(19) United States
(12) Patent Application Publication
(10) Pub. No.: US 2013/0210250 A1
(43) Pub. Date: Aug. 15, 2013

(54) CONVERTER AND PROGRAM

(71) Applicant: Sony Corporation, (US)

(72) Inventors: Kazuyoshi Takemura, Tokyo (JP); Takanori Washiro, Kanagawa (JP); Isao Soma, Saitama (JP); Kuniya Hayashi, Tokyo (JP); Kayoko Tanaka, Tokyo (JP); Yoichiro Sako, Tokyo (JP); Kazutoshi Serita, Tokyo (JP); Satoshi Higano, Kanagawa (JP)

(73) Assignee: Sony Corporation, Tokyo (JP)

(21) Appl. No.: 13/760,463

(22) Filed: Feb. 6, 2013

(30) Foreign Application Priority Data
Feb. 13, 2012 (JP) 2012-028855

(51) Int. Cl. G05B 1/01

(52) U.S. Cl. CPC G05B 1/01
USPC 439/170; 340/10.5

(57) ABSTRACT

There is provided a converter including a converting unit converting a communication mode of a connecting device having a connecting terminal.

### BACKGROUND

The present disclosure relates to a converter and a program.

As disclosed in JP 2003-110471A, for example, more authentication outlets and more authentication plugs are currently used. Such authentication outlets and authentication plugs authenticate each other through mutual communications therebetween.

### SUMMARY

Unfortunately, these authentication outlets and authentication plugs are in a transitional period, and there are a large number of outlets and plugs having no function for authentication communication (i.e., carries out no communication). There is no unified communication standard for authentication outlets and authentication plugs, and thus there exist authentication outlets and authentication plugs in variety of communication standards. Hence, such a technology has been desired that enables mutual communication among connecting devices having different communication modes (such as presence or absence of communication and communication standards, etc.).

According to an embodiment of the present disclosure, there is provided a converter which includes a converting unit converting a communication mode of a connecting device having a connecting terminal.

According to another embodiment of the present disclosure, there is provided a program that allows a computer to realize a conversion of a communication mode of a connecting device having a connecting terminal.

The converter is connected to one of plural connecting devices having different communication modes so as to adjust the communication mode of this connecting device to the communication mode of the other connecting device.

According to the embodiments of the present disclosure described above, mutual availability among plural connecting devices having different communication modes is realized by adjusting the communication modes among the connecting devices.

### BRIEF DESCRIPTION OF THE DRAWINGS

FIG. 1 is a perspective view showing that a converter according to the first embodiment of the present disclosure is connected to a plug;

FIG. 2 is a perspective view showing that the converter is connected to the plug;

FIG. 3 is a perspective view showing that the converter carries out communication;

FIG. 4 is a block diagram showing inner configurations of the converter and the plug;

FIG. 5 is a block diagram showing an inner configuration of the converter;

FIG. 6 is a block diagram showing inner configurations of the converter and a controller;

FIG. 7 is a block diagram of an inner configuration of the plug;

FIG. 8 is a block diagram of an inner configuration of the plug;

FIG. 9 is a block diagram showing an inner configuration of a converter according to the second embodiment of the present disclosure;

FIG. 10 is a block diagram showing an inner configuration of a plug carrying out communication with the converter;

FIG. 11 is a block diagram showing an inner configuration of the plug;

FIG. 12 is a block diagram showing an inner configuration of a converter according to the third embodiment of the present disclosure;

FIG. 13 is a block diagram showing an inner configuration of the converter;

FIG. 14 is a block diagram showing an inner configuration of a converter according to the fourth embodiment of the present disclosure;

FIG. 15 is a block diagram showing an inner configuration of a converter according to the fifth embodiment of the present disclosure;

FIG. 16 is a block diagram showing an inner configuration of a converter according to the sixth embodiment of the present disclosure; and

FIG. 17 is a block diagram showing an inner configuration of a converter according to the seventh embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be provided in the following order.

### 1. Outline

2. First embodiment (example of converting communication mode from power line communication to wireless communication)

2-1. General configuration of converter, etc.

2-2. Inner configuration of converter, etc.

3. Second embodiment (example of converting communication mode from no communication to wireless communication)
4. Third embodiment (example of converting communication mode from no communication to power line communication)
5. Fourth embodiment (example of converting communication mode from wireless communication to no communication)
6. Fifth embodiment (example of converting communication mode from power line communication to no communication)
7. Sixth embodiment (example of converting communication mode from wireless communication to power line communication)
8. Seventh embodiment (example of converting communication mode from power line communication to wireless communication)

### 9. Variations

### 1. Outline

The present embodiments convert the communication mode of a connecting device (such as an outlet and a plug). The communication mode in the present embodiments denotes concepts including availability of communication (presence or absence of communication), a distinction between wired communication and wireless communication, and communication standards, etc., for example.

Specifically, the present embodiments carry out a mutual conversion between wireless communication and power line communication. In the wireless communication and the power line communication of the present embodiments, techniques pertinent to the NFC (near field communication) and the RFID (radio frequency identification) are used, and the technology according to the present disclosure may also be applicable to wireless communications and power line communications other than these techniques. The power line communication of the present embodiments includes communication carried out through a contact between terminals of each device (so-called contact communication), and communication carried out by connecting terminals of each device with wires.

The power line communication of the present embodiments employs techniques pertinent to the NFC and the RFID, so that the following effects may be expected. Specifically, wired communication using an existing PLC technique requires a communicating device including a relatively large circuit such as a so-called PLC modem, for example. Hence, such wired communication using the existing PLC technique may increase in cost for the communicating device, and may also limit the size of the communicating device. In addition, in the wired communication using the existing PLC technique, no communication is available if no power (power signal) is fed to the communicating device (out of operation because a main power is OFF, for example).

A communicating device used in the NFC and in the RFID has a much smaller circuit compared to that of the existing PLC modem; therefore, such a communicating device may be reduced in size into an IC (integrated circuit) chip, for example. Since more wireless communication devices (such as mobile phones) including such communicating devices have been spread well, the above communicating device becomes inexpensive compared to the existing PLC modem.

In addition, in the techniques pertinent to the NFC and the RFID, one of wireless communicating devices transmits a high frequency signal to the other of the wireless communicating devices, thereby supplying power to the other wireless communicating device. The other communicating device operates with the supplied power, and carries out load modulation, thereby transmitting stored information.

The power line communication according to the present embodiments realizes reduction in size of each power line communicating device (such as a converter, a plug and an outlet described later, for example), and allows reduction in manufacturing cost thereof. In addition, since each power line communicating device operates with a high frequency signal, the power line communicating devices communicate with each other even if no power is supplied for the power line.

A frequency of the high frequency signal may include at least one of 130 to 135 kHz, 13.56 MHz, 56 MHz, 433 MHz, 954.2 MHz, 954.8 MHz, 2441.75 MHz, and 2448.875 MHz, but the frequency of the high frequency signal according to the present embodiments may not be limited to these frequencies. It is preferred that the frequency of the high frequency signal is at least different from the frequency of the power signal (50 Hz or 60 Hz).

### 2. First Embodiment

Description will now be provided on the first embodiment. In the first embodiment, the communication mode of the connecting device is converted from the power line communication to the wireless communication.

### [2-1. General Configuration of Converter, Etc.]

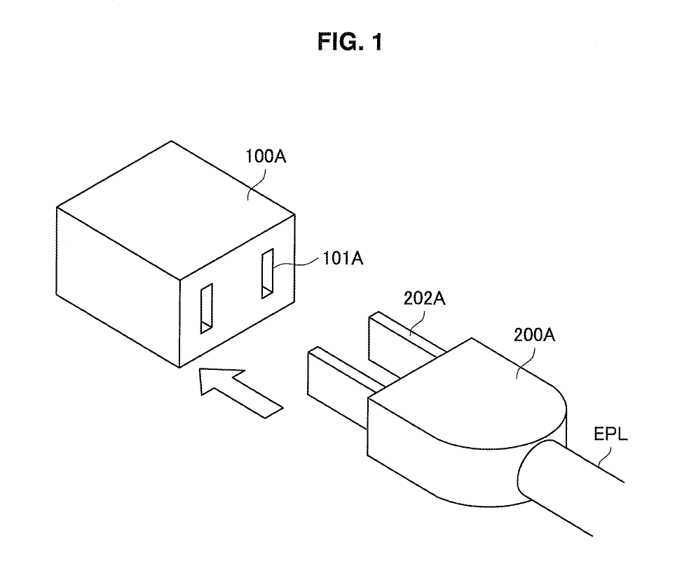

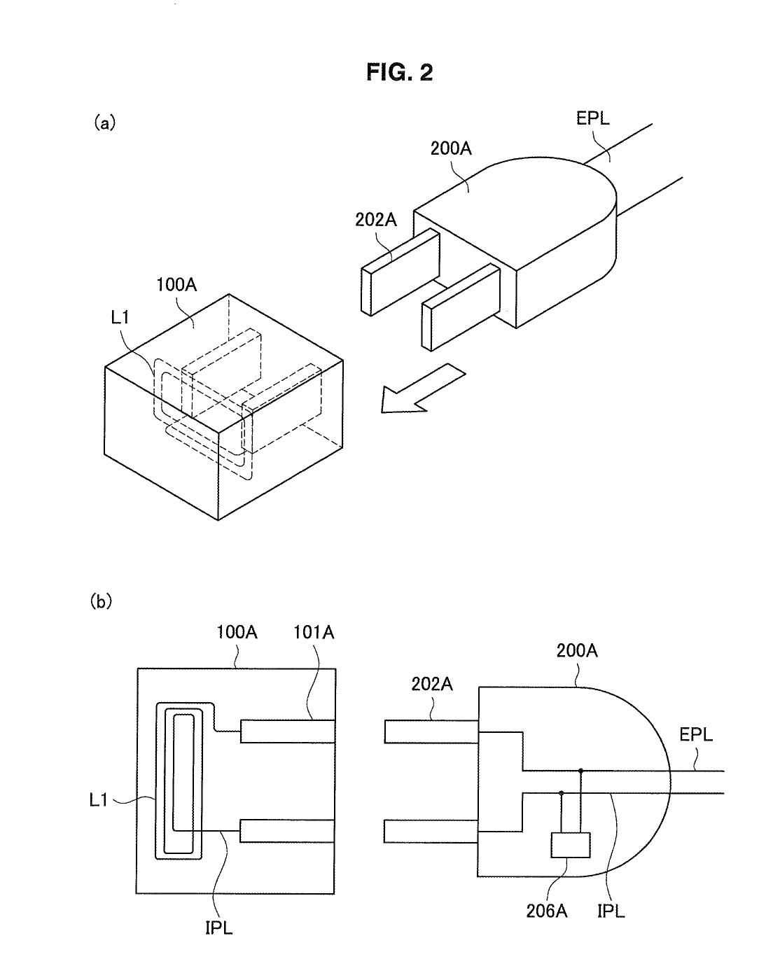

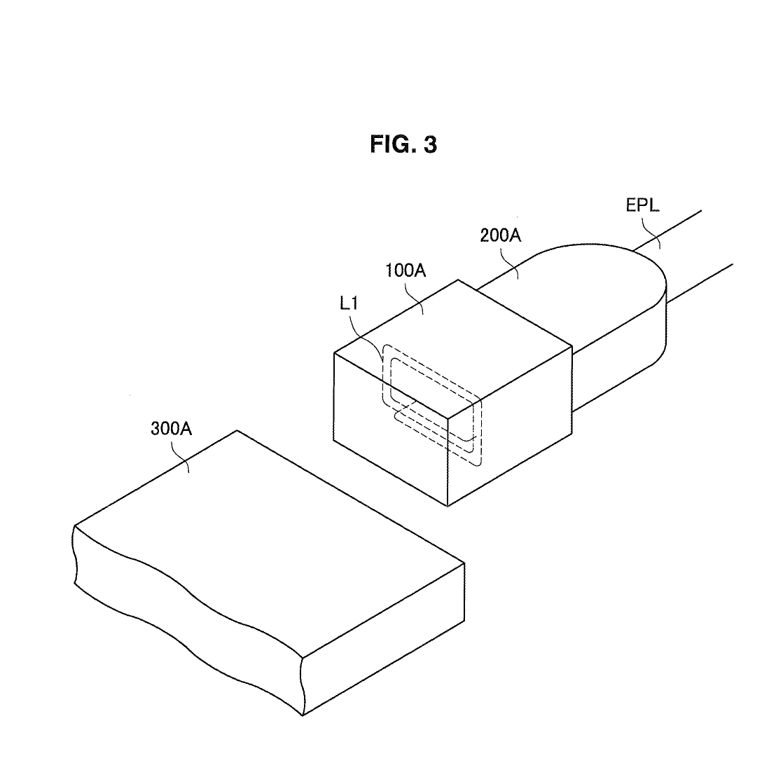

With reference to FIG. 1 to FIG. 4, the general configuration of a converter 100A, a plug 200A, and a controller 300A will be described. The converter 100A converts the communication mode of the plug (connecting device) 200A from the power line communication to the wireless communication. Specifically, the converter 100A adjusts the plug 200A to be available for the wireless communication. The converter 100A mainly includes apertures 101A, a coil L1, and an internal power line IPL. Blade terminals 202A of the plug 200A are inserted into the apertures 101A. The internal power line IPL connects the apertures 101A to the coil L1. The coil L1 is a so-called wireless antenna, and wirelessly transmits a high frequency response signal provided from the plug 200A to the controller 300A. The coil L1 receives a high frequency signal transmitted from the controller 300A, and transmits the high frequency signal to the plug 200A through the internal power line IPL.

The plug 200A is a connecting device having a function of the power line communication. The plug 200A mainly includes the blade terminals (connecting terminals) 202A, a power line communicating unit 206A, and the internal power line IPL. The blade terminals 202A are inserted into the apertures 101A so as to be connected to the internal power line IPL of the converter 100A. The power line communicating unit 206A is connected to the internal power line IPL. The power line communicating unit 206A carries out load modulation so as to generate a high frequency response signal, and transmits the high frequency response signal to the internal power line IPL. The internal power line IPL connects the blade terminals 202A to an external power line EPL extending from electronic equipment (not shown). The controller 300A transmits the high frequency signal as the driving power to the antenna L1.

Thus, a user connects the plug 200A to the converter 100A. Specifically, the user inserts the blade terminals 202A into the apertures 101A. Through this connection, the power line communicating unit 206A and the coil L1 become conducted with each other. The user puts (holds) the converter 100A close to the controller 300A. At this time, the coil L1 receives the high frequency signal from the controller 300A, and then transmits the high frequency signal to the power line communicating unit 206A. The power line communicating unit 206A operates with this high frequency signal. The power line communicating unit 206A carries out the load modulation so as to transmit the high frequency response signal. This high frequency response signal is supplied to the coil L1 through the internal power line IPL. The coil L1 wirelessly transmits the high frequency response signal to the controller 300A. Accordingly, the controller 300A wirelessly communicates with the plug 200A. Specifically, the converter 100A adjusts the plug 200A to be available for the wireless communication.

### [2-2. Inner Configuration of Converter, Etc.]

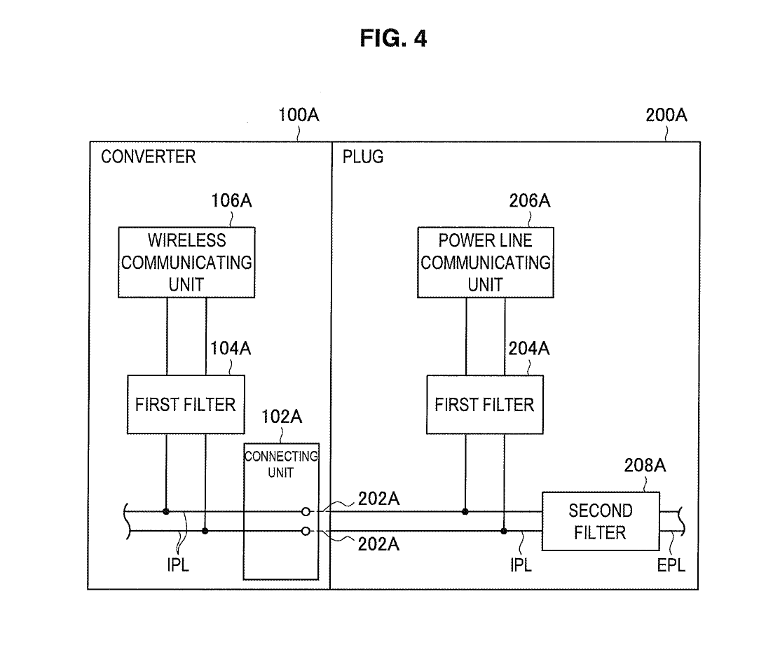

The inner configuration of the converter 100A, the plug 200A, and the controller 300A will be described with reference to FIG. 4 to FIG. 8. As shown in FIG. 4, the converter 100A includes a connecting unit 102A, a first filter 104A, a wireless communicating unit 106A, and the internal power line IPL. In this configuration, the communication mode of the plug 200A is converted. Specifically, the connecting unit 102A, the first filter 104A, the wireless communicating unit 106A, and the internal power line IPL constitute a converting unit.

The connecting unit 102A includes the apertures 101A. The apertures 101A are connected to the internal power line IPL. The first filter 104A is connected between the wireless communicating unit 106A and the internal power line IPL, so as to function for filtering signals transmitted from the internal power line IPL. More specifically, the first filter 104A has a function for blocking power signal (signal supplied from an external power source) without blocking the high frequency signal and the high frequency response signal among the signals transmitted from the internal power line IPL. By this configuration, the first filter 104A prevents the power signals that may be noises to the wireless communicating unit 106A from reaching the wireless communicating unit 106A.

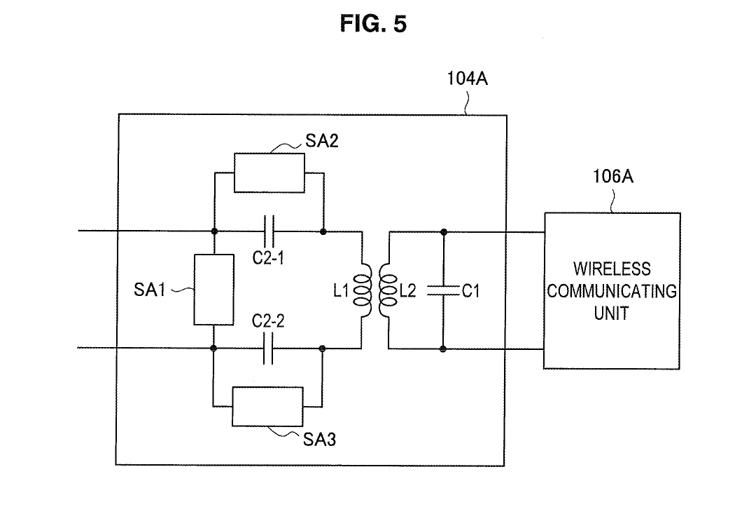

The first filter 104A includes inductors L1, L2, capacitors C1 to C2-2, and surge absorbers SA1 to SA3, as shown in FIG. 5. It is needless to say that the configuration of the first filter 104A of the present embodiment is not limited to the configuration of FIG. 5.

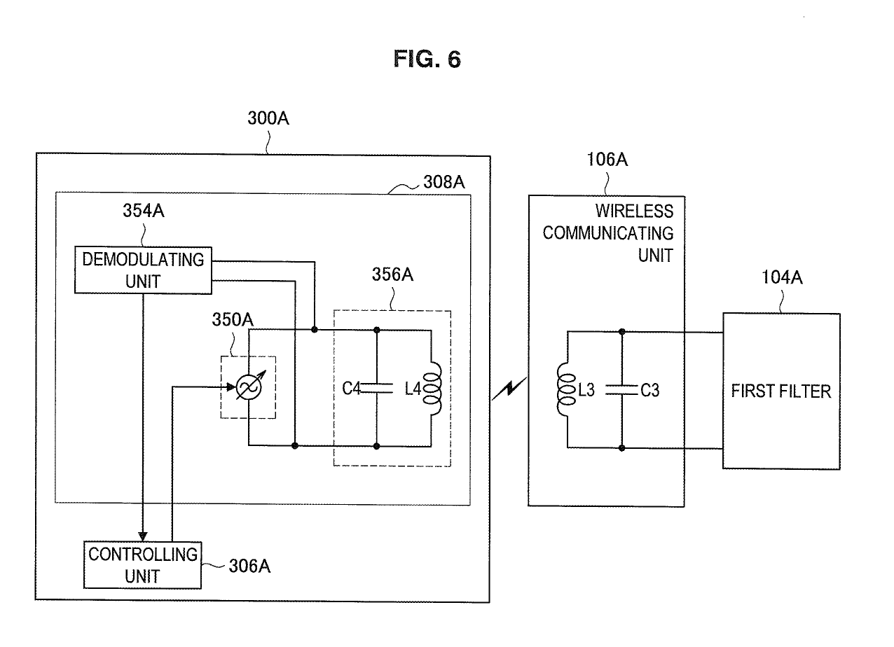

The wireless communicating unit 106A functions as a so-called communicating antenna. As shown in FIG. 6, the wireless communicating unit 106A includes a coil L3 having a predetermined inductance, and a capacitor C3 having a predetermined electrostatic capacity, which constitute a resonant circuit. The resonant frequency of the wireless communicating unit 106A may be a frequency of a high frequency signal at 13.56 [MHz], for example. In the above configuration, the wireless communicating unit 106A receives the high frequency signal wirelessly transmitted from the controller 300A, and transmits the high frequency signal to the plug 200A through the power line communication. The wireless communicating unit 106A receives the high frequency response signal transmitted from the plug 200A through the power line communication, and transmits the high frequency response signal to the controller 300A through the wireless communication. The internal power line IPL connects the apertures 101A of the connecting unit 102A to the first filter 104A.

As shown in FIG. 4, the plug 200A includes the blade terminals 202A, a first filter 204A, the power line communicating unit 206A, a second filter 208A, and the internal power line IPL. The blade terminals 202A are capable of being inserted into the apertures 101A of the converter 100A, and are connected to the internal power line IPL.

The first filter 204A is connected between the power line communicating unit 206A and the internal power line IPL, and functions for filtering the signals transmitted from the internal power line IPL. More specifically, the first filter 204A has a function for blocking the electric power signal without blocking the high frequency signal and the high frequency response signal among the signals transmitted from the internal power line IPL. The specific configuration of the first filter 204A is the same as that of the first filter 104A.

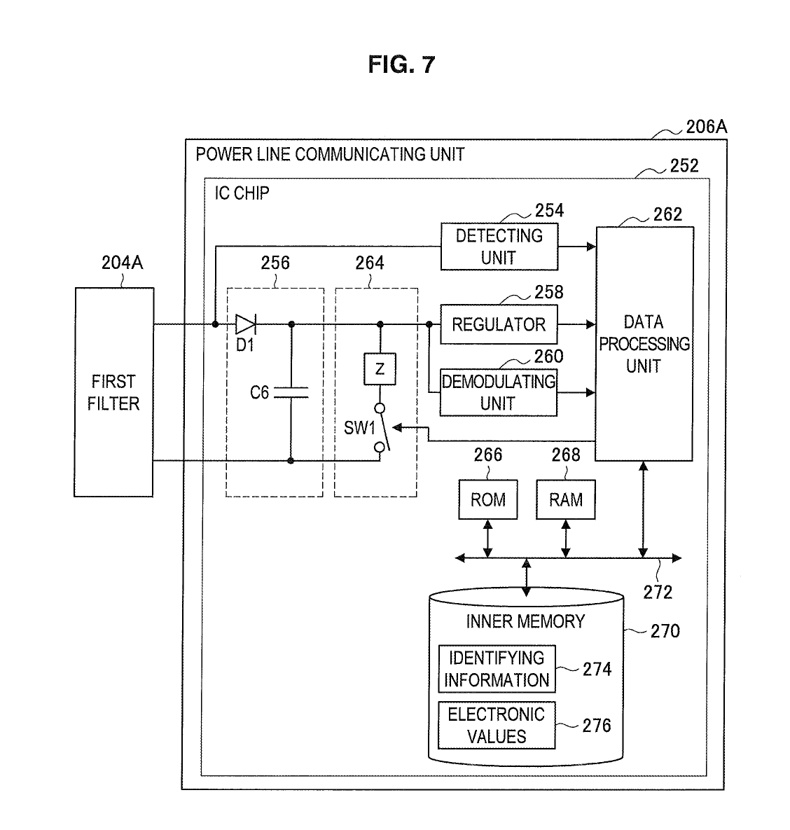

The power line communicating unit 206A operates with the high frequency signal from the controller 300A. The power line communicating unit 206A carries out the load modulation so as to generate the high frequency response signal, and transmits the high frequency response signal to the internal power line IPL. FIG. 7 is an explanatory diagram showing an example of the power line communicating unit 206A. In FIG. 7, the first filter 204A is also illustrated. The power line communicating unit 206A includes an IC chip 252 that demodulates the received high frequency signal, and transmits the high frequency response signal through the load modulation. In the plug 200A according to the present embodiment, each component included in the IC chip 252 shown in FIG. 7 may not be formed in an IC chip.

The IC chip 252 includes a detecting unit 254, a wave detecting unit 256, a regulator 258, a demodulating unit 260, a data processing unit 262, and a load modulating unit 264. Although not shown in FIG. 7, the IC chip 252 may further include a protective circuit (not shown) for preventing excessive voltages or excessive currents from being applied to the data processing unit 262. An example of the protective circuit (not shown) may include a clamping circuit constituted by diodes or the like, for example.

The IC chip 252 includes a ROM 266, a RAM 268, and an inner memory 270, etc. The data processing unit 262 is connected to the ROM 266, the RAM 268, and the inner memory 270 via a bus 272 as a data path, for example.

The ROM 266 stores control data such as programs and operation parameters to be used by the data processing unit 262. The RAM 268 temporarily stores the programs to be executed by the data processing unit 262, calculation results, execution statuses, and others.

The inner memory 270 is a storage unit included in the IC chip 252, and may have a tamper resistance, for example, and reading, writing, or updating of data is carried out on the inner memory 270 by the data processing unit 262. The inner memory 270 stores various data such as identifying information (identifying information of electronic equipment to which the plug 200A is connected), electronic values, and application data. FIG. 7 shows an example of the inner memory 270 that stores the identifying information 274 and electronic values 276.

The detecting unit 254 generates a detecting signal in square waves, for example, based on the high frequency signal, and transmits the detecting signal to the data processing unit 262. The data processing unit 262 uses the transmitted detecting signal as a processing clock for data processing, for example. The above detecting signal is generated based on the high frequency signal transmitted from the controller 300A, therefore, this detecting signal is synchronized with the frequency of the high frequency signal. The IC chip 252 includes the detecting unit 254, which allows the processing with the controller 300A to be synchronized with the controller 300A.

The wave detecting unit 256 rectifies the voltage in accordance with the received high frequency signal (also referred to as a “received voltage”, hereinafter). The wave detecting unit 256 may be constituted by a diode D1 and a capacitor C6, for example, but the configuration of the wave detecting unit 256 is not limited to this.

The regulator 258 smoothens and regulates the received voltage as a driving voltage, and then transmits the driving voltage to the data processing unit 262. The regulator 258 is capable of using a direct current component of the received voltage as the driving voltage.

The demodulating unit 260 demodulates the high frequency signal based on the received voltage, and transmits data corresponding to the high frequency signal (data signal binarized into a high level and a low level). The demodulating unit 260 is capable of transmitting an AC component of the received voltage as data.

The data processing unit 262 operates with the driving voltage transmitted from the regulator 258 as the power source, and processes data demodulated on the demodulating unit 260. The data processing unit 262 may be constituted by the MPU, for example, but the configuration of the data processing unit 262 is not limited to this.

The data processing unit 262 selectively generates a control signal for controlling the load modulation pertinent to a response to the controller 300A based on the processing results. The data processing unit 262 also selectively transmits the control signal to the load modulating unit 264.

The load modulating unit 264 includes a load Z and a switch SW1, for example, and selectively connects (enables) the load Z in accordance with the control signal transmitted from the data processing unit 262, so as to carry out the load modulation. The load Z may be constituted by a resistance having a predetermined resistance value, but the configuration of the load Z is not limited to this. The switch SW1 may be constituted by a p-channel MOSFET (metal oxide semiconductor field effect transistor), or an n-channel MOSFET, for example, but the configuration of the switch SW1 is not limited to this.

In the above configuration, the IC chip 252 processes the received high frequency signal, and superimposes and transmits the high frequency response signal on the power line through the load modulation. It is needless to say that the configuration of the IC chip 252 according to the present embodiment is not limited to the configuration of FIG. 7.

Through the configuration of FIG. 7, the power line communicating unit 206A operates with the supplied driving power from the received high frequency signal, so as to execute the processing indicated by the received high frequency signal, and transmits the high frequency response signal in accordance with this processing through the load modulation.

The second filter 208A connects an external power line EPL extending from electronic equipment (not shown) to the internal power line IPL. The second filter 208A functions for filtering the signals to be transmitted through the internal power line IPL. More specifically, the second filter 208A has a function for at least blocking the high frequency signal transmitted from the controller 300A, and the high frequency response signal transmitted from the power line communicating unit 206A without blocking the power signal supplied through the internal power line IPL. Specifically, the second filter 208A transmits the power signal from the outlet to the external power line if the plug 200A is inserted into the outlet, for example. In other words, the second filter 208A functions as a power splitter.

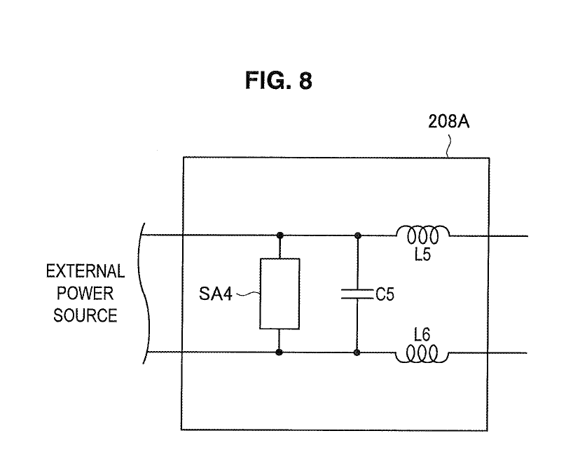

FIG. 8 is an explanatory drawing showing an example of the configuration of the second filter 208A. The second filter 208A includes inductors L5, L6, a capacitor C5, and a surge absorber SA4. It is needless to say that the configuration of the second filter 208A according to the present embodiment is not limited to the configuration of FIG. 8.

As shown in FIG. 6, the controller 300A includes a controlling unit 306A and a wireless communicating unit 308. The controlling unit 306A may be constituted by an MPU (micro processing unit) or an integrated circuit in which various processing circuits are integrated, and controls each unit of the controller 300A. More specifically, the controlling unit 306A transmits a high frequency signal generating instruction and a high frequency signal transmission-stop instruction to the wireless communicating unit 308A, and executes various processing (management of electronic values, etc.) based on the high frequency response signal transmitted from the wireless communicating unit 308A.

The wireless communicating unit 308A carries out wireless communication with the wireless communicating unit 106A of the converter 100A, and functions as a reader/writer (or interrogator) in the NFC or the like. Specifically, the wireless communicating unit 308A includes a high frequency signal generating unit 350A, a demodulating unit 354A, and a high frequency transceiver 356A. The wireless communicating unit 308A may further include an encoding circuit (not shown) and a communication collision preventing (anti-collision) circuit, or the like, for example.

In response to the high frequency signal generating instruction transmitted from the controlling unit 306A, for example, the high frequency signal generating unit 350A generates the high frequency signal in accordance with the high frequency signal generating instruction. In response to the high frequency signal transmission-stop instruction indicating transmission stop of the high frequency signal that is transmitted from the controlling unit 306A, for example, the high frequency signal generating unit 350A stops generating the high frequency signal.

FIG. 6 shows an AC power source as the high frequency signal generating unit 350A, but the high frequency signal generating unit 350A according to the present embodiment is not limited to this. For example, the high frequency signal generating unit 350A according to the present embodiment may include a modulating circuit (not shown) for carrying out an ASK (amplitude shift keying) modulation, and an amplifier circuit (not shown) for amplifying the transmission from the modulating circuit. The high frequency signal generated by the high frequency signal generating unit 350A includes transmission request for the plug 200A to transmit identifying information, and various processing instruction for the plug 200A for, example.

The demodulating unit 354A detects variation in voltage amplitude at the antenna end of the high frequency signal generating unit 350A through an envelope detection, and binarizes the detected signal, so as to demodulate the high frequency response signal transmitted from the wireless communicating unit 106A. The method of demodulating the high frequency response signal on the demodulating unit 354A is not limited to this, and the response signal may be demodulated using the phase shift of the voltage at the antenna end of the high frequency signal generating unit 350A.

The high frequency transceiver 356A includes an inductor (coil) L4 having a predetermined inductance and a capacitor C4 having a predetermined electrostatic capacity, which constitutes a resonant circuit, for example. The resonant frequency of the high frequency transceiver 356A may be a frequency of a high frequency signal of 13.56 [MHz], for example. In the above configuration, the high frequency transceiver 356A transmits the high frequency signal generated by the high frequency signal generating unit 350A, and receives the high frequency response signal transmitted from the wireless communicating unit 106A.

Through the above configuration, the converter 100A converts the communication mode of the plug 200A from the power line communication to the wireless communication. Specifically, the converter 100A transmits the high frequency response signal provided from the power line communicating unit 206A of the plug 200A to the controller 300A through the wireless communication. The converter 100A receives the high frequency signal transmitted from the controller 300A, and transmits this high frequency signal to the power line communicating unit 206A. Accordingly, the converter 100A adjusts the plug 200A for the power line communication to be available for the wireless communication. This allows the user to use the plug 200A even in the environment in which only the wireless communication is available. The converter 100A may mutually convert the communication standards if the communication standard (such as the format or frequency of the high frequency signal) of the power line communication carried out by the plug 200A is different from the communication standard of the wireless communication carried out by the controller 300A. In this case, a communication standard converting unit for converting the communication standard may be disposed between the first filter 104A and the wireless communicating unit 106A. This communication standard converting unit is embodied by the same configuration as the above described power line communicating unit 206A. Specifically, the communication standard converting unit converts the format of the high frequency response signal from the plug 200A, and transmits the converted high frequency response signal to the wireless communicating unit 106A through the frequency modulation. The communication standard converting unit converts the format of the high frequency signal from the wireless communicating unit 106A, and transmits the converted high frequency signal to the first filter 104A through the frequency modulation.

### 2. Second Embodiment

The second embodiment will now be described. The second embodiment converts the communication mode of the outlet that carries out no communication (having no communicating function) from no communication to the wireless communication. Specifically, the second embodiment provides the outlet that carries out no communication with a wireless communicating function (such as an authenticating function). In other words, the second embodiment changes availability of the authentication, or presence and absence of the authentication as the communication mode.

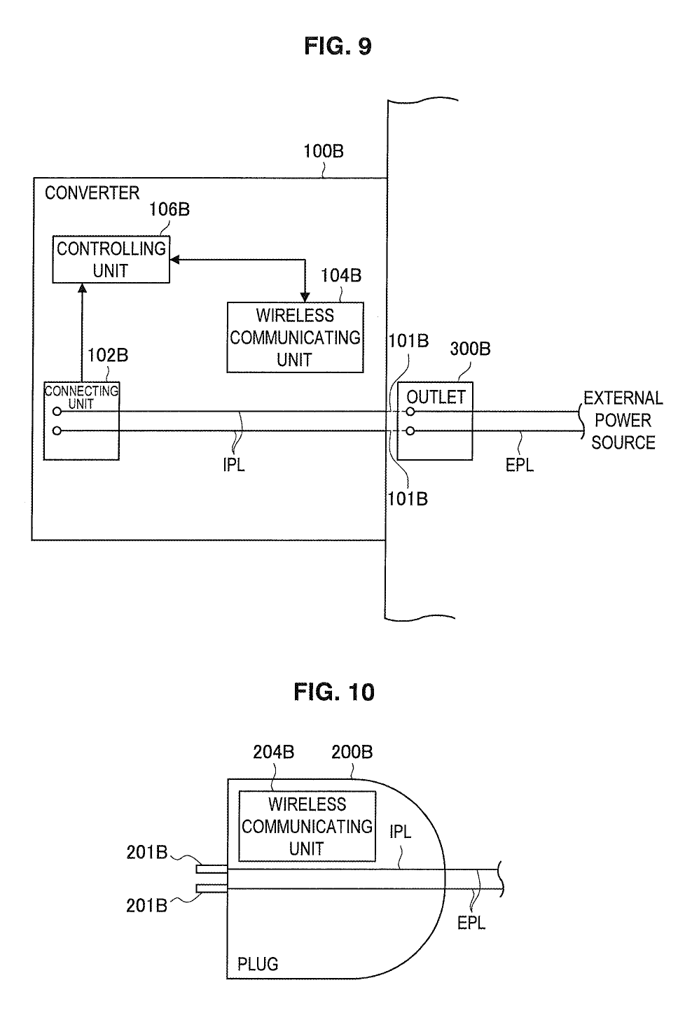

Configuration of a converter 100B according to the second embodiment will now be described with reference to FIG. 9. The converter 100B is detachably attached to an outlet 300B that carries out no communication, and includes blade terminals 101B, a connecting unit 102B, a wireless communicating unit 104B, a controlling unit 106B, and the internal power line IPL. In this configuration, the communication mode of the outlet 300B is converted. Specifically, the blade terminals 101B, the connecting unit 102B, the wireless communicating unit 104B, the controlling unit 106B, and the internal power line IPL constitute a converting unit.

The blade terminals 101B are inserted into apertures of the outlet 300B. The blade terminals 101B are connected to the external power line EPL when the blade terminals 101B are inserted in the apertures. The connecting unit 102B includes apertures. The apertures are connected to the internal power line IPL. The connecting unit 102B may transmit a connection confirming signal to the controlling unit 106B when a plug 200B described later is connected to the connecting unit 102B. The internal power line IPL connects the connecting unit 102B to the blade terminals 101B.

The wireless communicating unit 104B carries out the wireless communication with a wireless communicating unit 204B described later, and functions as a reader and writer (or an interrogator) in the NFC or the like. The wireless communicating unit 104B has the same specific configuration as the configuration of the above described wireless communicating unit 308A.

The controlling unit 106B may be constituted by an MPU (micro processing unit) or an integrated circuit in which various processing circuits are integrated, and controls each unit of the converter 100B. More specifically, the controlling unit 106B transmits the high frequency signal generating instruction, and the high frequency signal transmission-stop instruction to the wireless communicating unit 104B, and executes various processing (management of electronic values, etc.) based on the high frequency response signal transmitted from the wireless communicating unit 104B. The controlling unit 106B carries out the above processing by reading a program stored on the integrated circuit and executing this program. This program is used for converting the communication mode of the outlet 300B from no communication to the wireless communication. This configuration of the program is the same in the other embodiments. The controlling unit 106B may transmit the high frequency signal generating instruction to the wireless communicating unit 104B when the connection confirming signal is provided by the connecting unit 102B. The controlling unit 106B has the same specific configuration as that of the above described controlling unit 306A.

The outlet 300B is a connecting device that carries out no communication, and has apertures. The apertures are connected to the external power source through the external power line EPL. The converter 100B has the above configuration; therefore, the converter 100B provides the outlet 300B with a wireless communicating function simply by connecting the converter 100B to the outlet 300B. Specifically, the converter 100B adjusts the outlet 300B to be available for the wireless communication.

The converter 100B is connected to the plug 200B shown in FIG. 10, for example. The plug 200B is a connecting device having a wireless communicating function, and includes blade terminals 201B, the wireless communicating unit 204B, and the internal power line IPL. The plug 200B is connected to electronic equipment through the external power line EPL.

The blade terminals 201B are capable of being inserted into the apertures of the connecting unit 102B. The blade terminals 201B are connected to the internal power line IPL of the converter 100B when the blade terminals 201B are inserted in the apertures. The internal power line IPL of the plug 200B connects the blade terminals 201B to the external power line EPL. Accordingly, the insertion of the blade terminals 101B of the converter 100B into the apertures of the outlet 300B as well as the insertion of the blade terminals 201B of the plug 200B into the apertures of the connecting unit 102B allows the electronic equipment to be conducted with the external source.

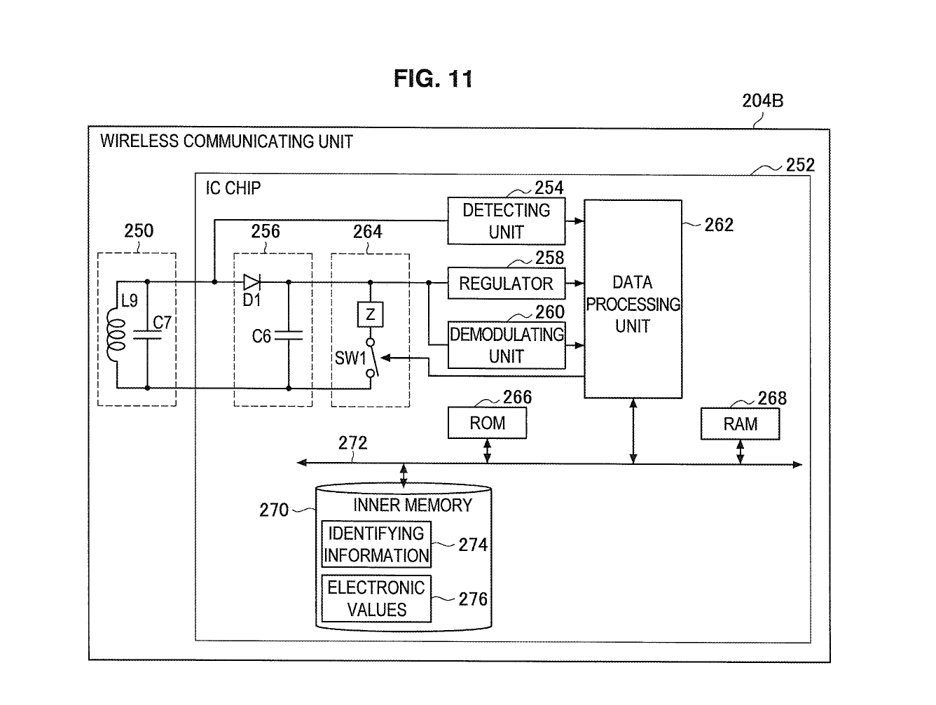

The wireless communicating unit 204B operates with the high frequency signal provided from the converter 100B. The wireless communicating unit 204B generates the high frequency response signal through the load modulation, and transmits the high frequency response signal to the wireless communicating unit 104B of the converter 100B through the wireless communication. FIG. 11 shows an explanatory drawing showing an example of the wireless communicating unit 204B. The wireless communicating unit 204B includes a high frequency transceiver 250 in addition to the IC chip 252 shown in FIG. 7.

The high frequency transceiver 250 includes a coil L9 having a predetermined inductance, and a capacitor C7 having a predetermined electrostatic capacity, which constitute a resonant circuit. The resonant frequency of the high frequency transceiver 250 may be a frequency of a high frequency signal of 13.56 [MHz], for example. In the above configuration, the high frequency transceiver 250 receives the high frequency signal transmitted from the wireless communicating unit 104B, and transmits the high frequency response signal to the wireless communicating unit 104B. More specifically, the high frequency transceiver 250 generates an induced voltage by electromagnetic induction in response to the receipt of the high frequency signal, and transmits the received voltage generated by resonant oscillations of the induced voltage at a predetermined resonant frequency to the IC chip 252. The high frequency transceiver 250 transmits the high frequency response signal transmitted from the IC chip 252 through the load modulation to the controller 300A.

Through the above configuration, the converter 100B converts the communication mode of the outlet 300B from no communication to the wireless communication. This means that the converter 100B transmits the high frequency signal to the plug 200B, and receives the high frequency response signal from the plug 200B through the wireless communication. Accordingly, the converter 100B adjusts the outlet 300B having no communicating function to be available for the wireless communication. In other words, the outlet 300B becomes available to the user even if the user carries only the plug 200B for the wireless communication with him or her.

### 3. Third Embodiment

The third embodiment will now be described. The third embodiment converts the communication mode of an outlet that carries out no communication (has no communicating function) from no communication to the power line communication. Specifically, the third embodiment provides the outlet that carries out no communication with a power line communicating function (such as an authenticating function). In other words, the third embodiment changes availability of the authentication, or presence and absence of the authentication as the communication mode.

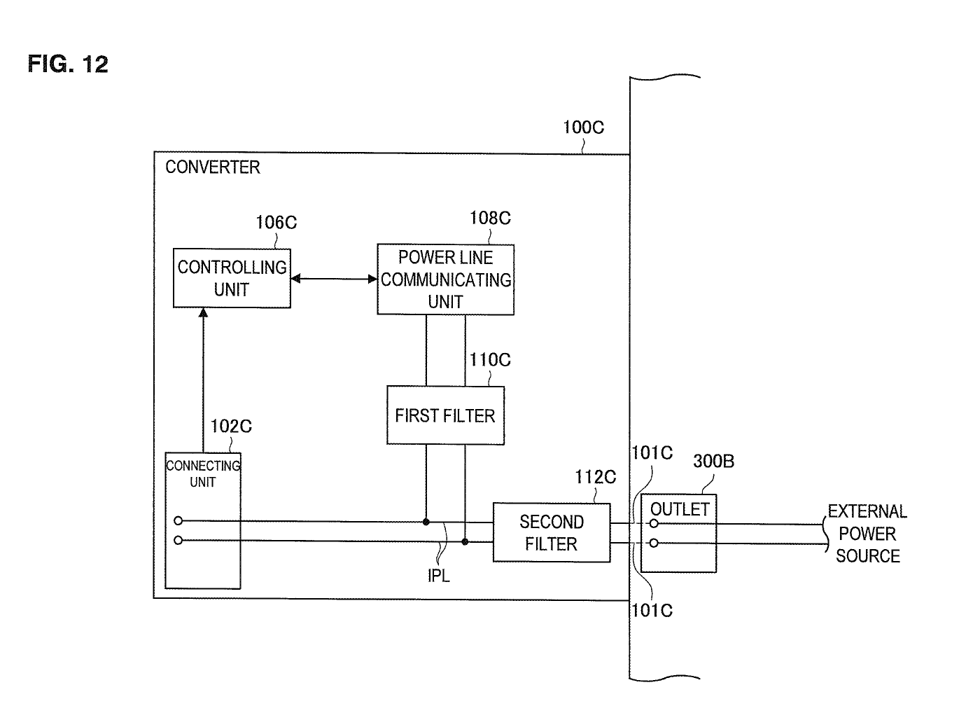

A converter 100C according to the third embodiment will now be described based on FIG. 12. The converter 100C is detachably attached to the outlet 300B that carries out no communication, and includes blade terminals 101C, a connecting unit 102C, a controlling unit 106C, a power line communicating unit 108C, a first filter 110C, a second filter 112C, and the internal power line IPL. In this configuration, the communication mode of the outlet 300B is converted. Specifically, the blade terminals 101C, the connecting unit 102C, the controlling unit 106C, the power line communicating unit 108C, the first filter 110C, the second filter 112C, and the internal power line IPL constitute a converting unit. The converter 100C allows the power line communication with the above described plug 200A.

The blade terminals 101C are capable of being inserted into apertures of the outlet 300B. The blade terminals 101C are connected to the external power line EPL when the blade terminals 101C are inserted in the apertures. The connecting unit 102C includes apertures. The apertures are connected to the internal power line IPL. The connecting unit 102C may transmit the connection confirming signal to the controlling unit 106C when the above described plug 200A is connected to the connecting unit 102C. The internal power line IPL connects the connecting unit 102C to the blade terminals 101C.

The controlling unit 106C may be constituted by an MPU (micro processing unit) or an integrated circuit in which various processing circuits are integrated, and controls each unit of the converter 100C. More specifically, the controlling unit 106C transmits the high frequency signal generating instruction, and the high frequency signal transmission-stop instruction to the power line communicating unit 108C, and executes various processing (management of electronic values, etc.) based on the high frequency response signal transmitted from the power line communicating unit 108C. The controlling unit 106C may transmit the high frequency signal generating instruction to the power line communicating unit 108C when the connection confirming signal is provided by the connecting unit 102C. The controlling unit 106C has the same specific configuration as that of the above described controlling unit 306A.

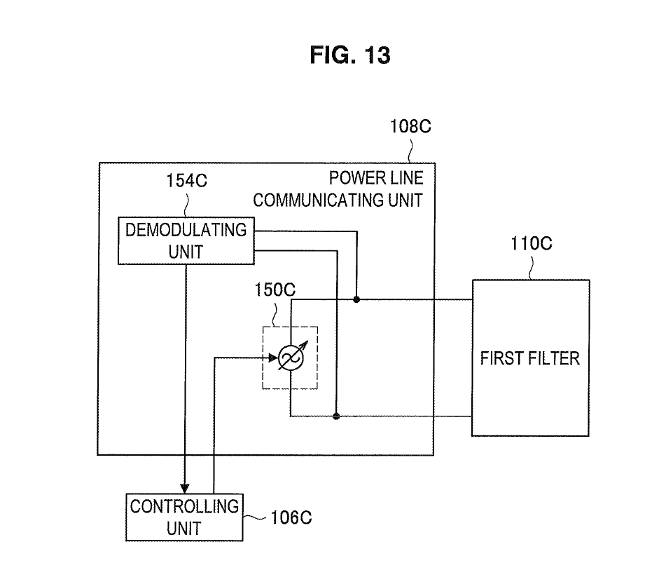

The power line communicating unit 108C carries out the power line communication with the above described power line communicating unit 206A, and functions as a reader and writer (or an interrogator) in the NFC or the like. FIG. 13 shows an example of the configuration of the power line communicating unit 108C. The power line communicating unit 108C includes a high frequency signal generating unit 150C and a demodulating unit 154C. The power line communicating unit 108C may further include an encoding circuit (not shown) and a communication collision preventing (anti-collision) circuit, and others, for example.

The high frequency signal generating unit 150C carries out the same processing as that of the above described high frequency signal generating unit 350A. Specifically, in response to the high frequency signal generating instruction transmitted from the controlling unit 106C, the high frequency signal generating unit 150C generates a high frequency signal in accordance with the high frequency signal generating instruction. In response to a high frequency signal transmission-stop instruction indicating transmission stop of the high frequency signal that is transmitted from the controlling unit 106C, for example, the high frequency signal generating unit 150C stops generating the high frequency signal.

The modulating unit 154C detects variation in voltage amplitude between the high frequency signal generating unit 150C and the first filter 110C through an envelope detection, and binarizes the detected signal, so as to demodulate the high frequency response signal transmitted from the plug 200A. The modulating unit 154C transmits the demodulated high frequency response signal to the controlling unit 106C. The method of demodulating the high frequency response signal on the demodulating unit 154C is not limited to this, and the high frequency response signal may be demodulated using the phase shift of voltage between the high frequency signal generating unit 150C and the first filter 110C.

The first filter 110C is connected between the power line communicating unit 108C and the internal power line IPL, so as to function for filtering the signals transmitted from the internal power line IPL. More specifically, the first filter 110C has a function for blocking only the power signal without blocking the high frequency signal and the high frequency response signal among the signals transmitted from the internal power line IPL. Through this configuration, the first filter 110C prevents the power signal that may be noises to the power line communicating unit 108C from reaching the power line communicating unit 108C. The specific configuration of the first filter 110C is the same as that of the above described first filter 104A.

The second filter 112C functions for connecting the blade terminals 101C to the internal power line IPL. The second filter 112C functions for filtering the signals to be transmitted through the internal power line IPL. More specifically, the second filter 112C has a function for blocking the high frequency response signal transmitted from the plug 200A, and the high frequency signal transmitted from the power line communicating unit 108C without blocking the power signal supplied from the external power source. Specifically, the second filter 112C transmits the power signal from the external power source to electronic equipment when the blade terminals 101C of the converter 100C are inserted into the apertures of the outlet 300B, and the blade terminals 201A of the plug 200A are inserted into the apertures of the connecting unit 102C. In other words, the second filter 112C functions as a so-called power splitter. The specific configuration of the second filter 112C is the same as that of the above described second filter 208A.

The converter 100C carries out the power line communication with the above described plug 200A, for example. The connecting unit 102C transmits the connection confirming signal to the controlling unit 106C when the blade terminals 201A of the plug 200A are inserted into the apertures. In response to the transmitted signal, the controlling unit 106C transmits the high frequency signal generating instruction to the power line communicating unit 108C. Based on this instruction, the power line communicating unit 108C transmits the high frequency signal. The high frequency signal reaches the plug 200A through the first filter 110C and the internal power line IPL. The high frequency signal then reaches the power line communicating unit 206A through the internal power line IPL of the plug 200A and the first filter 204A. The power line communicating unit 206A operates with this high frequency signal. The power line communicating unit 206A generates the high frequency response signal through the load modulation, and transmits the high frequency response signal to the first filter 204A. The high frequency response signal reaches the power line communicating unit 108C along a reverse route to the route of the high frequency signal. This configuration allows the converter 100C to carry out the power line communication with the plug 200A.

Through the above configuration, the converter 100C converts the communication mode of the outlet 300B from no communication to the power line communication. Specifically, the converter 100C transmits the high frequency signal to the plug 200A, and receives the high frequency response signal from the plug 200A through the power line communication. In this manner, the converter 100C adjusts the outlet 300B having no communicating function to be available for the power line communication. In other words, the outlet 300B becomes available to the user even if the user carries only the plug 200A for the power line communication with him or her.

### 4. Fourth Embodiment

The fourth embodiment will now be described. The fourth embodiment converts the communication mode of the authentication outlet from the wireless communication to no communication. Specifically, the fourth embodiment cancels the wireless communicating function (authenticating function) of the authentication outlet. In other words, the fourth embodiment changes availability of the authentication, or presence and absence of the authentication as the communication mode.

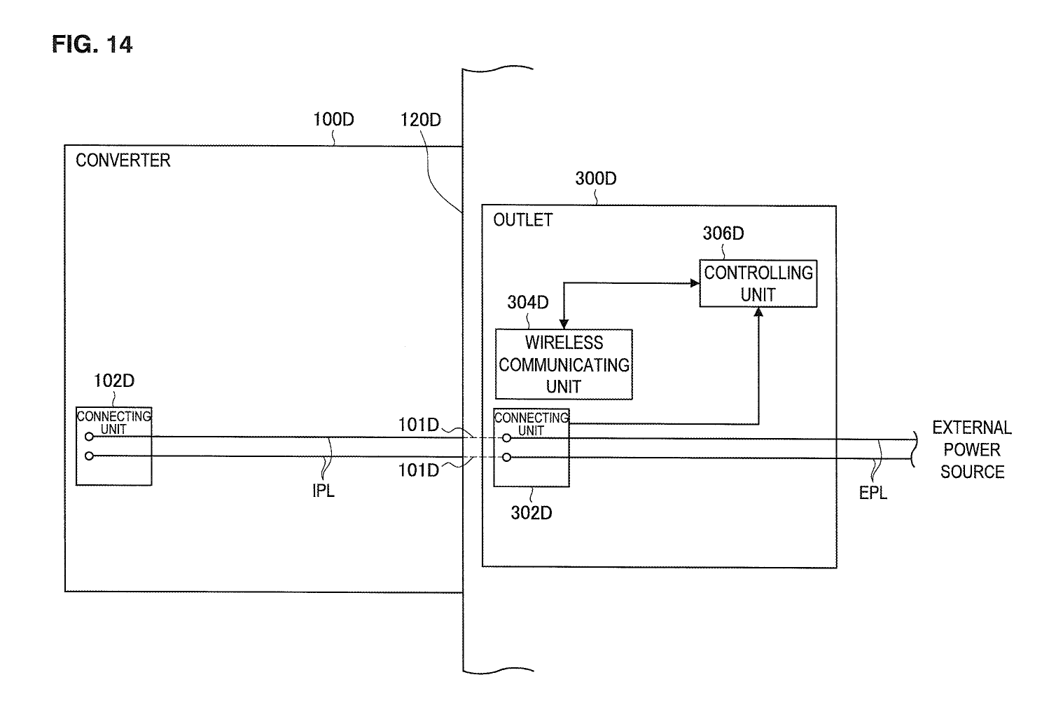

With reference to FIG. 14, configuration of an outlet 300D according to the fourth embodiment will be described. The outlet 300D is detachably attached to a converter 100D that carries out no communication, and includes a connecting unit 302D, a wireless communicating unit 304D, a controlling unit 306D, and the external power line EPL.

The connecting unit 302D includes apertures. The apertures are connected to the external power line EPL. The external power line EPL is connected to the external power source (not shown). The connecting unit 302D may transmit the connection confirming signal to the controlling unit 306D when a plug having a wireless communicating function such as the above described plug 200B is connected to the connecting unit 302D. The external power line EPL connects the apertures of the connecting unit 302D to the external power source.

The wireless communicating unit 304D carries out the wireless communication with the plug having the wireless communicating function, and functions as a reader and writer (or an interrogator) in the NFC or the like. The specific configuration of the wireless communicating unit 304D is the same as that of the wireless communicating unit 308A.

The controlling unit 306D may be constituted by an MPU (micro processing unit) or an integrated circuit in which various processing circuits are integrated, and controls each unit of the outlet 300D. More specifically, the controlling unit 306D transmits a high frequency signal generating instruction and a high frequency signal transmission-stop instruction to the wireless communicating unit 304D, and executes various processing (management of electronic values, etc.) based on the high frequency response signal transmitted from the wireless communicating unit 304D. The controlling unit 306D may transmit the high frequency signal generating instruction to the wireless communicating unit 304D when the connection confirming signal provided by the connecting unit 302D. The specific configuration of the controlling unit 306D is the same as that of the above described controlling unit 306A. The wireless communication between the outlet 300D and the plug 200B is carried out in the same manner as than in the wireless communication between the converter 100B and the plug 200B.

The configuration of the converter 100D according to the fourth embodiment will now be described with reference to FIG. 14. The converter 100D is detachably attached to the outlet 300D having a wireless communicating function. The converter 100D includes blade terminals 101D, a connecting unit 102D, and the internal power line IPL. The converter 100D is connected to a plug that carries out no communication.

The blade terminals 101D are capable of being inserted into the apertures of the connecting unit 302D. The blade terminals 101D are connected to the external power line EPL when the blade terminals 101D are inserted into the apertures. The connecting unit 102C includes apertures. These apertures are connected to the internal power line IPL. The internal power line IPL connects the connecting unit 102D to the blade terminals 101D. Hence, the converter 100D carries out no communication.

Of the outer wall of the converter 100D, a portion opposing the outlet 300D is made of material blocking electromagnetic waves. Accordingly, a signal is prevented from leaking out from the outlet 300D to the outside. Specifically, the converter 100D prevents the outlet 300D from recognizing another plug having the wireless communicating function while the plug having no communicating function is connected to the outlet 300D through the converter 100D. The above material may be used for the entire outer wall of the converter 100D. Instead of using the above material for the outer wall of the converter 100D, the size of the converter 100D may be greater than the communication range of the wireless communicating unit 304D, or this latter way may be used in combination with the above former way.

Through the above configuration, the converter 100D converts the communication mode of the outlet 300D from the wireless communication to no communication. Accordingly, the converter 100D adjusts the outlet 300D to the plug that carries out no communication. In other words, the outlet 300D becomes available to the user even if the user carries only the plug that carries out no communication with him or her.

### 5. Fifth Embodiment

The fifth embodiment will now be described. The fifth embodiment converts the communication mode of an authentication outlet from the power line communication to no communication. Specifically, the fifth embodiment cancels the power line communicating function (authenticating function) of the authentication outlet. In other words, the fifth embodiment changes availability of the authentication, or presence and absence of the authentication as the communication mode.

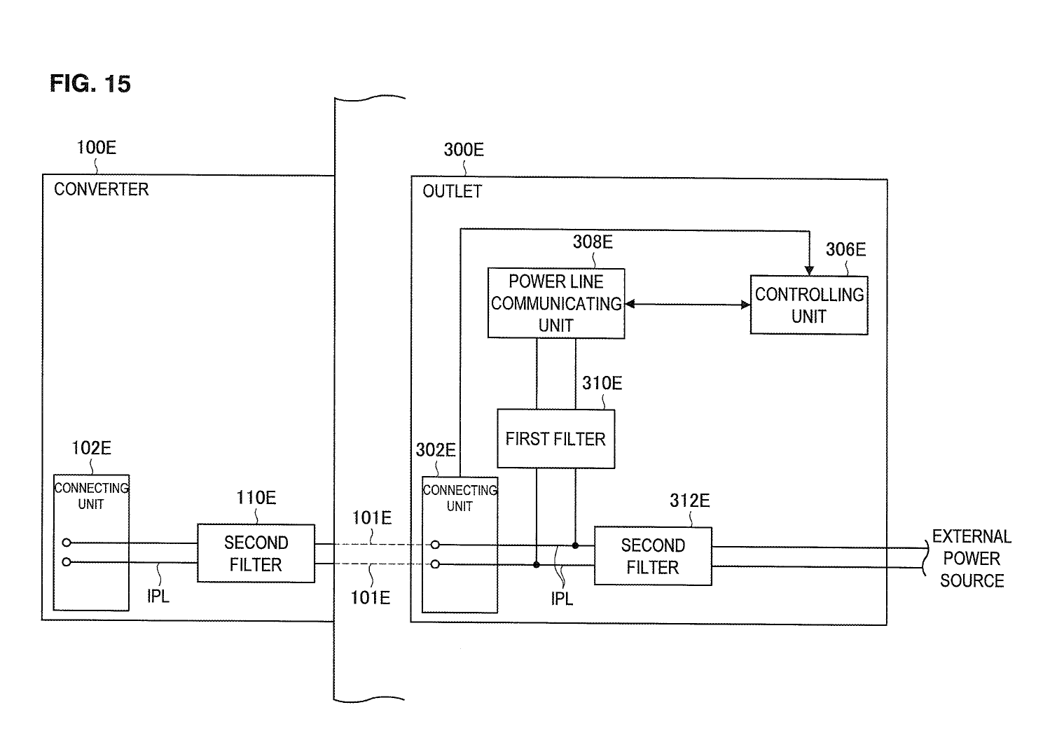

With reference to FIG. 15, an outlet 300E according to the fifth embodiment will now be described. The outlet 300E is detachably attached to a converter 100E that carries out no communication. The outlet 300E includes a connecting unit 302E, a controlling unit 306E, a power line communicating unit 308E, a first filter 310E, a second filter 312E, the internal power line IPL, and the external power line EPL. The outlet 300E carries out the power line communication with the above described plug 200A, for example.

The connecting unit 302E includes apertures. The apertures are connected to the internal power line IPL. The connecting unit 302E may transmit the connection confirming signal to the controlling unit 306E when the above described plug 200A is connected to the connecting unit 302E, for example. The internal power line IPL connects the connecting unit 302E to the second filter 312E.

The controlling unit 306E may be constituted by an MPU (micro processing unit) or an integrated circuit in which various processing circuits are integrated, and controls each unit of the outlet 300E. More specifically, the controlling unit 306E transmits the high frequency signal generating instruction, and the high frequency signal transmission-stop instruction to the power line communicating unit 308E, and executes various processing (management of electronic values, etc.) based on the high frequency response signal transmitted from the power line communicating unit 308E. The controlling unit 306E may transmit the high frequency signal generating instruction to the power line communicating unit 308E when the connection confirming signal is provided by the connecting unit 302E. The controlling unit 306E has the same specific configuration as that of the above described controlling unit 306A.

The power line communicating unit 308E carries out the power line communication with the above described plug 200A, and functions as a reader and writer (or an interrogator) in the NFC or the like. The power line communicating unit 308E has the same specific configuration as that of the above described power line communicating unit 108C.

The first filter 310E is connected between the power line communicating unit 308E and the internal power line IPL, and functions for filtering the signals transmitted from the internal power line IPL. More specifically, the first filter 310E blocks the power signal without blocking the high frequency signal and the high frequency response signal among the signals transmitted from the internal power line IPL. In this configuration, the first filter 310E prevents the power signal that may be noises to the power line communicating unit 308E from reaching the power line communicating unit 308E. The specific configuration of the first filter 310E is the same as that of the first filter 104A.

The second filter 312E connects the internal power line IPL to the external power line EPL. The external power line EPL is connected to the external power source. The second filter 312E functions for filtering the signals to be transmitted through the internal power line IPL. More specifically, the second filter 312E functions for blocking the high frequency response signal transmitted from the plug 200A and the high frequency signal transmitted from the power line communicating unit 308E without blocking the power signal supplied from the external power source.

The second filter 312E may transmit the power signal from the external power source to electronic equipment when the converter 100E is connected to the outlet 300E, and the plug having no communicating function is connected to the converter 100E, for example. Specifically, the second filter 312E functions as a so-called power splitter. The specific configuration of the second filter 312E is the same as that of the second filter 208A. The power line communication between the outlet 300E and the plug 200A is carried out in the same manner as that in the power line communication between the converter 100C and the plug 200A.

Configuration of the converter 100E according to the fifth embodiment will now be described with reference to FIG. 15. The converter 100E is detachably attached to the outlet 300E having the power line communicating function. The converter 100E includes blade terminals 101E, a connecting unit 102E, a second filter 110E, and the internal power line IPL. The converter 100E is connected to the plug that carries out no communication. In this configuration, the communication mode of the outlet 300E is converted. In other words, the blade terminals 101E, the connecting unit 102E, the second filter 110E, and the internal power line IPL constitute a converting unit.

The blade terminals 101E are capable of being inserted into the apertures of the connecting unit 302E. The blade terminals 101E are connected to the external power line EPL when the blade terminals 101E are inserted into these apertures. The blade terminals 101E are connected to the second filter 110E. The connecting unit 102E includes apertures. These apertures are connected to the internal power line IPL. The internal power line IPL connects the second filter 110E to the connecting unit 102E.

The second filter 110E connects the internal power line IPL to the blade terminals 101E. The second filter 110E functions for filtering the signals to be transmitted from the outlet 300E. More specifically, the second filter 110E functions for blocking the high frequency signal transmitted from the outlet 300E without blocking the power signal supplied from the external power source. In other words, the second filter 110E prevents the high frequency signal transmitted from the outlet 300E from being transmitted to the plug that carries out no communication (and to the electronic equipment connected to the plug). Accordingly, the converter 100E carries out no communication.

Through the above configuration, the converter 100E converts the communication mode of the outlet 300E from the power line communication to no communication. Accordingly, the converter 100E adjusts the outlet 300E to the plug that carries out no communication. In other words, the outlet 300E becomes available to the user even if the user carries only the plug that carries out no communication with him or her.

### 6. Sixth Embodiment

The sixth embodiment will now be described. The sixth embodiment converts the communication mode of the outlet 300D from the wireless communication to the power line communication. In other words, the sixth embodiment adjusts the outlet 300D to be available for the power line communication.

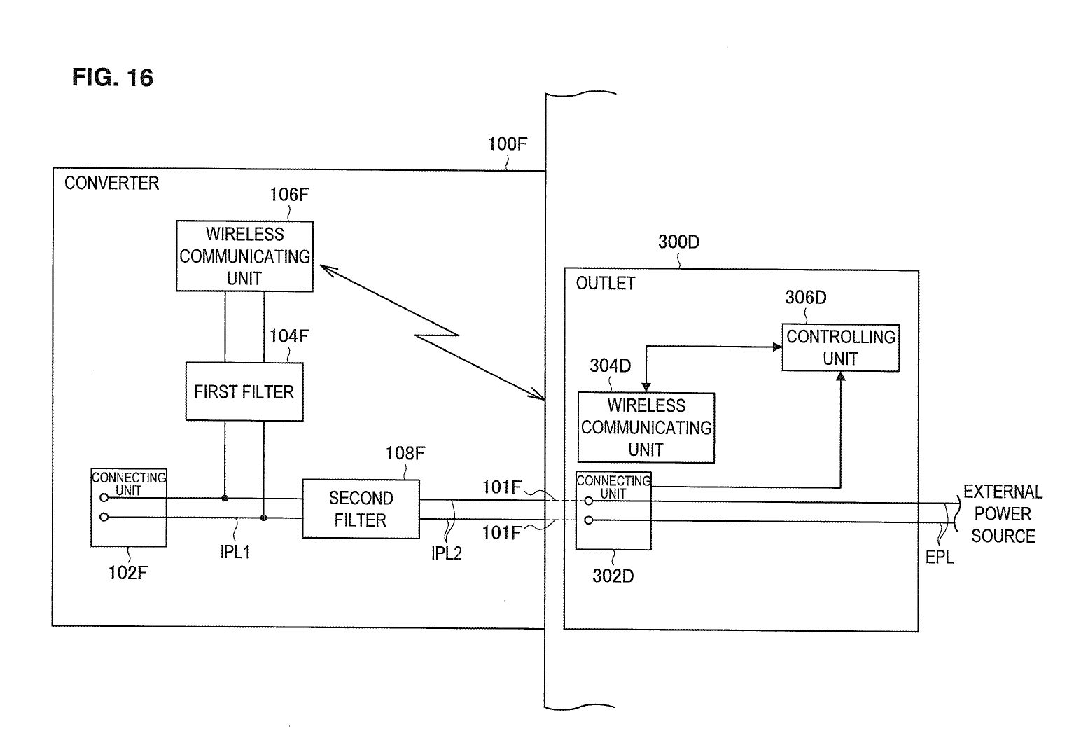

FIG. 16 shows the configuration of a converter 100F according to the sixth embodiment. The converter 100F is detachably attached to the outlet 300D having a wireless communicating function, and includes blade terminals 101F, a connecting unit 102F, a first filter 104F, a wireless communicating unit 106F, a second filter 108F, and internal power lines IPL1, IPL2. The converter 100F is connected to a plug that carries out the power line communication such as the above described plug 200A, for example. In this configuration, the communication mode of the outlet 300D is converted. Specifically, the blade terminals 101F, the connecting unit 102F, the first filter 104F, the wireless communicating unit 106F, the second filter 108F, and the internal power lines IPL1, IPL2 constitute a converting unit.

The blade terminals 101F are capable of being inserted into the apertures of the connecting unit 302D. The blade terminals 101F are connected to the external power line EPL when the blade terminals 101F are inserted into the apertures. The connecting unit 102F includes apertures. The blade terminals 201A of the plug 200A are capable of being inserted into these apertures. These apertures are connected to the internal power line IPL1. The internal power line IPL1 connects the second filter 108F to the connecting unit 102F. The internal power line IPL2 connects the second filter 108F to the blade terminals 101F.

The first filter 104F is connected between the wireless communicating unit 106F and the internal power line IPL1, and functions for filtering the signals transmitted from the internal power line IPL1. More specifically, the first filter 104F has a function for blocking the power signal without blocking the high frequency signal and the high frequency response signal among the signals transmitted from the internal power line IPL1. Through this configuration, the first filter 104F prevents the power signal that may be noises to the wireless communicating unit 106F from reaching the wireless communicating unit 106F. The specific configuration of the first filter 104F is the same as that of the first filter 104A.

The wireless communicating unit 106F functions as a so-called communicating antenna. The configuration of the wireless communicating unit 106F is the same as that of the above described wireless communicating unit 106A. The wireless communicating unit 106F receives the high frequency signal transmitted from the outlet 300D through the wireless communication, and transmits the high frequency signal to the first filter 104F. The wireless communicating unit 106F receives the high frequency response signal transmitted from the plug 200A through the internal power line IPL1 and others, and transmits the high frequency response signal to the wireless communicating unit 304D through the wireless communication. The wireless communication between the wireless communicating unit 106F and the wireless communicating unit 304D is carried out in the same manner as that in the above described wireless communication between the converter 100A and the controller 300A. The power line communication between the wireless communicating unit 106F and the power line communicating unit 206A is carried out in the same manner as that in the above described power line communication between the converter 100A and the plug 200A.

The second filter 108F functions for connecting the internal power line IPL1 to the internal power line IPL2. The second filter 108F functions for filtering the signal to be transmitted from the plug 200A and the wireless communicating unit 106F. More specifically, the second filter 108F has a function for blocking the high frequency signal and the high frequency response signal transmitted from the plug 200A and the wireless communicating unit 106F without blocking the power signal supplied from the external power source. Specifically, the second filter 108F prevents the high frequency signal transmitted from the plug 200A and the wireless communicating unit 106F from being transmitted to the external power source.

Through the above configuration, the converter 100F converts the communication mode of the outlet 300D from the wireless communication to the power line communication. Accordingly, the converter 100F adjusts the outlet 300D to the plug that carries out the power line communication. In other words, the outlet 300D becomes available to the user even if the user carries only the plug for the power line communication with him or her.

If the communication standard (such as the format or frequency of the high frequency signal) of the wireless communication carried out by the outlet 300D is different from the communication standard of the power line communication carried out by the plug 200A, the converter 100F may mutually convert these communication standards. In this case, a communication standard converting unit for converting the communication standard may be disposed between the first filter 104F and the wireless communicating unit 106F. This communication standard converting unit is embodied by the same configuration as the above described power line communicating unit 206A. Specifically, the communication standard converting unit converts the format of the high frequency signal from the outlet 300D, and transmits the converted high frequency signal to the wireless communicating unit 106F through the frequency modulation. On the other hand, the communication standard converting unit converts the format of the high frequency response signal from the wireless communicating unit 106F, and transmits the converted high frequency response signal to the first filter 104F through the frequency modulation.

### 7. Seventh Embodiment

The seventh embodiment will now be described. The seventh embodiment converts the communication mode of the outlet 300E from the power line communication to the wireless communication. In other words, the seventh embodiment adjusts the outlet 300E to be available for the wireless communication.

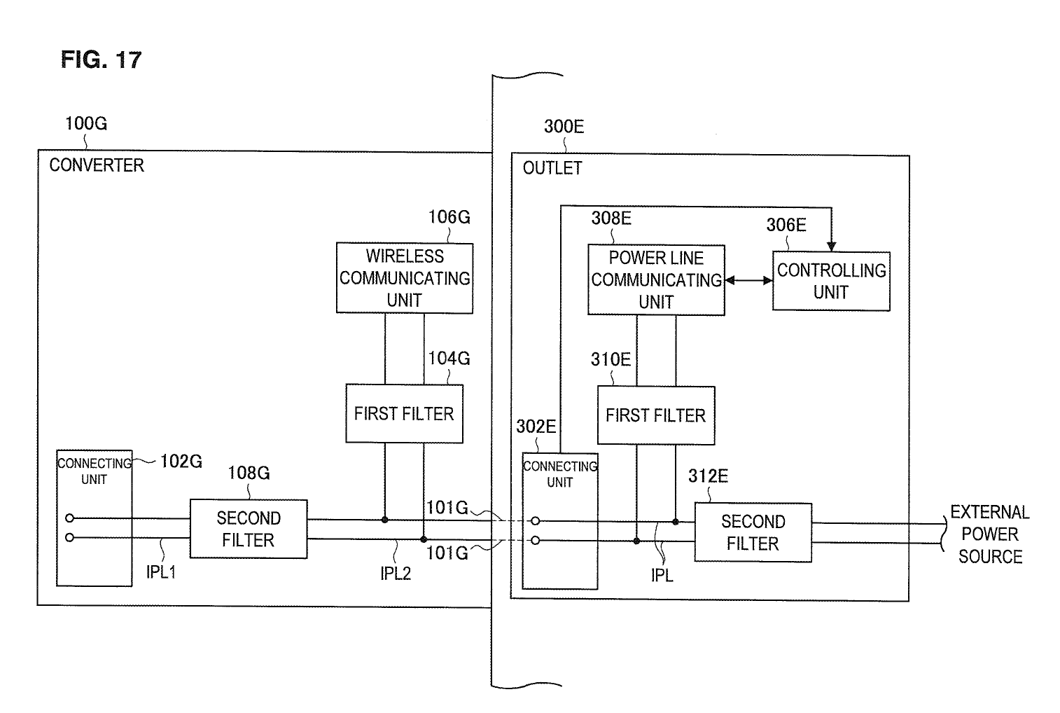

FIG. 17 shows the configuration of a converter 100G according to the seventh embodiment. The converter 100G is detachably attached to the outlet 300E having the power line communicating function, and includes blade terminals 101G, a connecting unit 102G, a first filter 104G, a wireless communicating unit 106G, a second filter 108G, and internal power lines IPL1, IPL2. The converter 100G is connected to a plug that carries out the wireless communication such as the above described plug 200B. In this configuration, the communication mode of the outlet 300E is converted. Specifically, the blade terminals 101G, the connecting unit 102G, the first filter 104G, the wireless communicating unit 106G, the second filter 108G, and the internal power lines IPL1, IPL2 constitute a converting unit.

The blade terminals 101G are capable of being inserted into the apertures of the connecting unit 302E. The blade terminals 101G are connected to the internal power lines IPL of the outlet 300E when the blade terminals 101G are inserted into the apertures. The connecting unit 102G includes apertures. The blade terminals 201B of the plug 200B are capable of being inserted into these apertures. The apertures are connected to the internal power line IPL1. The internal power line IPL1 connects the second filter 108G to the connecting unit 102G. The internal power line IPL2 connects the second filter 108G to the blade terminals 101G.

The first filter 104G is connected between the wireless communicating unit 106G and the internal power line IPL2, and functions for filtering the signals transmitted from the internal power line IPL2. More specifically, the first filter 104G blocks the power signal without blocking the high frequency signal and the high frequency response signal among the signals transmitted from the internal power line IPL2. In this configuration, the first filter 104G prevents the power signal that may be noises to the wireless communicating unit 106G from reaching the wireless communicating unit 106G. The specific configuration of the first filter 104G is the same as that of the first filter 104A.

The wireless communicating unit 106G functions as a so-called communicating antenna. The configuration of the wireless communicating unit 106G is the same as that of the above described wireless communicating unit 106A. The wireless communicating unit 106G receives the high frequency signal transmitted from the outlet 300E through the power line communication, and transmits this high frequency signal to the plug 200B through the wireless communication. The wireless communicating unit 106F receives the high frequency response signal transmitted from the plug 200B through the wireless communication, and transmits this high frequency response signal to the power line communicating unit 308E of the outlet 300E through the power line communication. The power line communication between the wireless communicating unit 106G and the power line communicating unit 308E is carried out in the same manner as that in the above described power line communication between the converter 100A and the plug 200A. The wireless communication between the wireless communicating unit 106G and the wireless communicating unit 204B is carried out in the same manner as that in the wireless communication between the converter 100A and the controller 300A.

The second filter 108G connects the internal power line IPL1 to the internal power line IPL2. The second filter 108G functions for filtering the signals to be transmitted from the outlet 300E and the wireless communicating unit 106G. More specifically, the second filter 108G has a function for blocking the high frequency signal and the high frequency response signal transmitted from the outlet 300E and the wireless communicating unit 106G without blocking the power signal supplied from the external power source. Specifically, the second filter 108G prevents the high frequency signal transmitted from the outlet 300E and the wireless communicating unit 106G from being transmitted to the external power source.

Through the above described configuration, the converter 100G converts the communication mode of the outlet 300E from the power line communication to the wireless communication. Accordingly, the converter 100G adjusts the outlet 300E to the plug that carries out the wireless communication. In other words, the outlet 300E becomes available to the user even if the user carries only the plug for the wireless communication with him or her.

If the communication standard (such as the format or frequency of the high frequency signal) of the power line communication carried out by the outlet 300E is different from the communication standard of the wireless communication carried out by the plug 200B, the converter 100G may mutually convert the communication standards. In this case, a communication standard converting unit for converting the communication standard may be disposed between the first filter 104G and the wireless communicating unit 106G. This communication standard converting unit is embodied by the same configuration as that of the above described power line communicating unit 206A. Specifically, the communication standard converting unit converts the format of the high frequency signal from the outlet 300E, and transmits the converted high frequency signal to the wireless communicating unit 106G through the frequency modulation. On the other hand, the communication standard converting unit converts the format of the high frequency response signal from the wireless communicating unit 106G, and transmits the converted high frequency response signal to the first filter 104G through the frequency modulation.

### 8. Variations

The above described converters are a so-called converting adaptor, and an extension code may be provided with a function of each converter. The technology of the present embodiments and the following variations may be applicable to various oversea outlets and converting plugs. In the second to seventh embodiments, the communication mode of the outlet is converted, but the communication mode of the plug may be converted, instead.

A variation of the second embodiment may include a converter that converts the communication mode of the plug that carries out no communication from no communication to the wireless communication. This converter includes a connecting unit into which blade terminals of the plug are inserted, and the wireless communicating unit 204B shown in FIG. 10, and the blade terminals to be inserted into the apertures of the outlet. In this variation, the plug becomes available to the user even if the user carries the outlet for the wireless communication with him or her. In this case, an IC chip of the converter previously stores information regarding electronic equipment connected to the plug.

A variation of the third embodiment may include a converter that converts the communication mode of the plug that carries out no communication from no communication to the power line communication. This converter has the substantially same configuration as that of the plug 200A shown in FIG. 4. It should be noted, however, that the external power line EPL is connected to the second filter 208A in the case of the plug 200A; but in this converter, the connecting unit is arranged in the second filter 208A instead of the external power line EPL. The plug that carries out no communication is connected to this connecting unit. In this variation, the plug becomes available to the user even if the user carries only the outlet for the power line communication with him or her. In this case, an IC chip of the converter previously stores information regarding electronic equipment connected to the plug.

A variation of the fourth embodiment may include a converter that converts the communication mode of the plug that carries out the wireless communication from the wireless communication to no communication. This converter has the same configuration as that of the above described converter 100D. It should be noted, however, that the side face of the converter where the connecting unit 102D is located is made of material for blocking electromagnetic waves. In this variation, the plug becomes available to the user even if the user carries only the outlet that carries out no communication with him or her.

A variation of the fifth embodiment may include such a converter that converts the communication mode of the plug that carries out the power line communication from the power line communication to no communication. This converter has the same configuration as that of the above described converter 100E. In this variation, the plug becomes available to the user even if the user carries only the outlet that carries out no communication with him or her.

A variation of the sixth embodiment may include such a converter that converts the communication mode of a plug that carries out the wireless communication from the wireless communication to the power line communication. This converter has the same configuration as that of the above described converter 100F. It should be noted, however, that the second filter is disposed between the first filter and the connecting unit. In this variation, the plug becomes available to the user even if the user carries only the outlet for the power line communication with him or her.

A variation of the seventh embodiment may include a converter that converts the communication mode of the plug that carries out the power line communication from the power line communication to the wireless communication. This converter is configured such that the converter 100A is provided with blade terminals, and the second filter is disposed between the blade terminals and the first filter. In this variation, the plug becomes available to the user even if the user carries only the outlet for the wireless communication with him or her.

As described above, the converter according to the present embodiments and the variations converts the communication modes of the outlet and the plug. Specifically, the converter according to the present embodiments and the variations adjusts the communication mode of the connecting device so as to allow the connecting device having different communication modes to mutually become available among the connecting devices.

With reference to the appended drawings, the preferred embodiments of the present disclosure have been described in detail, but the technical scope of the present disclosure is not limited to the examples of the embodiments. It should be understood by those skilled in the art that various modifications, combinations, sub-combinations and alterations may occur depending on design requirements and other factors insofar as they are within the scope of the appended claims or the equivalents thereof.

For example, in the above embodiments, the outlet and the plug are used as an example of the connecting device, but the technology according to the present disclosure may be applicable to other connecting devices. For example, the technology according to the present disclosure may be applicable to such a connecting device that connects a battery of an electric vehicle to an external power source.

Each embodiment and the variation thereof may be used in combination with each other. For example, the converter of the second embodiment and the converter according to the variation thereof may be connected to each other. This configuration allows the wireless communication between the plug and the outlet.

Similarly, the converter of the third embodiment and the converter according to the variation thereof may be connected to each other. This configuration allows the power line communication between the plug and the outlet. Similarly, the converter of the fourth embodiment and the converter according to the variation thereof may be connected to each other. This configuration allows a connection between the plug and the outlet with carrying out no communication.

Similarly, the converter of the fifth embodiment and the converter according to the variation thereof may be connected to each other. This configuration allows a connection between the plug and the outlet without carrying out the communication. Similarly, the converter of the sixth embodiment and the converter according to the variation thereof may be connected to each other. This configuration allows the power line communication between the plug and the outlet. Similarly, the converter of the seventh embodiment and the converter according to the variation thereof may be connected to each other. This configuration allows the wireless communication between the plug and the outlet.

Additionally, the present technology may also be configured as below.

(1) A converter including

a converting unit converting a communication mode of a connecting device having a connecting terminal.

(2) The converter according to (1), wherein

the connecting terminal is connectable to a power line,

the connecting device is capable of carrying out power line communication that is communication through the power line, and

the converting unit converts the communication mode of the connecting device from the power line communication to wireless communication.

(3) The converter according to (1), wherein

the communication mode includes availability of communication.

(4) The converter according to (3), wherein

the connecting device carries out no communication, and

the converting unit converts the communication mode of the connecting device from no communication to wireless communication.

(5) The converter according to (3), wherein

the connecting device carries out no communication, and

the converting unit converts the communication mode of the connecting device from no communication to power line communication.

(6) The converter according to (3), wherein

the connecting device is capable of carrying out wireless communication, and

the converting unit converts the communication mode of the connecting device from wireless communication to no communication.

(7) The converter according to (3), wherein

the connecting terminal is connectable to a power line,

the connecting device is capable of carrying out power line communication that is communication through the power line, and

the converting unit converts the communication mode of the connecting device from the power line communication to no communication.

(8) The converter according to (1), wherein

the connecting device is capable of carrying out wireless communication, and

the converting unit converts the communication mode of the connecting device from the wireless communication to power line communication.

(9) The converter according to (1), wherein

the communication mode includes a communication standard of the connecting device.

(10) The converter according to (1), wherein

the communication mode includes availability of an authentication, or presence and absence of an authentication.

(11) The converter according to any one of (1) to (10), wherein

communication carried out by at least one of the converting unit or the connecting device includes communication through load modulation.

(12) A program allowing a computer to realize a conversion of a communication mode of a connecting device having a connecting terminal.

The present disclosure contains subject matter related to that disclosed in Japanese Priority Patent Application JP 2012-028855 filed in the Japan Patent Office on Feb. 13, 2012, the entire content of which is hereby incorporated by reference.

What is claimed is:

1. A converter comprising
a converting unit converting a communication mode of a connecting device having a connecting terminal.

2. The converter according to claim 1, wherein
the connecting terminal is connectable to a power line,
the connecting device is capable of carrying out power line communication that is communication through the power line, and
the converting unit converts the communication mode of the connecting device from the power line communication to wireless communication.

3. The converter according to claim 1, wherein
the communication mode includes availability of communication.

4. The converter according to claim 3, wherein
the connecting device carries out no communication, and
the converting unit converts the communication mode of the connecting device from no communication to wireless communication.

5. The converter according to claim 3, wherein
the connecting device carries out no communication, and
the converting unit converts the communication mode of the connecting device from no communication to power line communication.

6. The converter according to claim 3, wherein
the connecting device is capable of carrying out wireless communication, and
the converting unit converts the communication mode of the connecting device from wireless communication to no communication.

7. The converter according to claim 3, wherein
the connecting terminal is connectable to a power line,
the connecting device is capable of carrying out power line communication that is communication through the power line, and
the converting unit converts the communication mode of the connecting device from the power line communication to no communication.

8. The converter according to claim 1, wherein
the connecting device is capable of carrying out wireless communication, and
the converting unit converts the communication mode of the connecting device from the wireless communication to power line communication.

9. The converter according to claim 1, wherein
the communication mode includes a communication standard of the connecting device.

10. The converter according to claim 1, wherein
the communication mode includes availability of an authentication, or presence and absence of an authentication.

11. The converter according to claim 1, wherein
communication carried out by at least one of the converting unit or the connecting device includes communication through load modulation.

12. A program allowing a computer to realize a conversion of a communication mode of a connecting device having a connecting terminal.
